(19) United States
(12) Patent Application Publication
(10) Pub. No.: US 2024/0342795 A1
(43) Pub. Date: Oct. 17, 2024

(54) METHOD FOR PRODUCING ALLOY POWDER AND ALLOY POWDER, PASTE AND CAPACITOR PREPARED BY THE METHOD

(71) Applicant: Jiangsu Boqian New Materials Stock Co., Ltd., Jiangsu (CN)

(72) Inventors: Dengyong Zhao, Jiangsu (CN); Jiabin Peng, Jiangsu (CN); Rongcheng Li, Jiangsu (CN); Gangqiang Chen, Jiangsu (CN); Wei Shi, Jiangsu (CN)

(73) Assignee: Jiangsu Boqian New Materials Stock Co., Ltd., Jiangsu (CN)

(21) Appl. No.: 18/036,651

(22) PCT Filed: Feb. 25, 2022
(86) PCT No.: PCT/CN2022/077815

§ 371 Date: May 12, 2023

(30) Foreign Application Priority Data
Nov. 11, 2021 (CN) 202111333058.4

(51) Int. Cl. B22F 9/06; B22F 1/054; B22F 1/142; B22F 1/145; C23C 8/12; H01G 4/008

(52) U.S. Cl. CPC B22F 9/06; B22F 1/054; B22F 1/142; B22F 1/147; C23C 8/12; H01G 4/008; B22F 2301/15; B22F 2302/25; B22F 2304/058; B22F 2998/10

(57) ABSTRACT

The present invention provides a method for producing an alloy powder, and an alloy powder, a paste, and a capacitor prepared by the method, wherein the method can obtain particles with a shape more similar to a spherical shape; the solidified particles form a denser surface layer after quenching; the chemically passivated surface layer is physically compacted by impact to form a dense protective layer. The high-stability alloy powder particles have a more stable chemical property and good dispersibility.

### TECHNICAL FIELD

The present invention relates to a method for producing a metal alloy powder suitable for electronic applications, and more particularly, to a method for producing a high-stability alloy powder as a conductive powder used in a conductive paste, and an alloy powder produced by the method, a conductive paste produced by the alloy powder, and a multilayer ceramic capacitor produced by the conductive paste.

### DESCRIPTION OF RELATED ART

The alloy powder, which is a main component of the conductive paste used in the electrode preparation process of the multilayer ceramic capacitor, needs to be kept to a minimum of unwanted impurities so as not to affect the conductivity. However, as more and more layers are stacked in a multilayer ceramic capacitor, it is required that the conductive powder has good electrical conductivity, and at the same time, it is required that the conductive powder has good bonding during co-firing with the ceramic insulating layer and the glass powder and has similar thermal expansion to prevent bulging and cracking between layers or bending and breaking of the ceramic body due to the difference in thermal expansion between the respective layers.

Therefore, the conductive powder needs to have a high sintering starting temperature and needs to have a good co-firing property with the oxide ceramic powder or glass powder. In addition, in the environment of the international division of labor, the time from the powder to the multilayer ceramic capacitor is long (sometimes more than 30 days), and the metal powder is required to have high stability. In order to maintain the stability of the powder, the powder may be packed in a vacuum or inert atmosphere, or the surface of the powder may be coated. In order to improve the co-firing property of metal powder and ceramic powder, the oxygen-enhanced or sulfur-enhanced process can be used to treat the powder. However, the specific surface area of micro-materials, especially nano-materials, is very large and the chemical activity is very strong, during the oxygen-enhanced or sulfur-enhanced process, the chemical reaction is easy to occur inside the powder particles, and the chemical passivation layer or coating layer on the powder surface is also easy to produce uneven and unstable problems. Furthermore, without effective control of the chemical passivation layer on the surface of the powder particles, reactions continue to be carried out inside the particles, which also affects the stability of the metal powder.

### SUMMARY

Given the problems in the background art, the present invention provides a method for producing a high-stability alloy powder by combining a thermal radiation solidification process, a quenching cooling process, a surface chemical passivation process, and a surface physical passivation process to produce a high-stability alloy powder.

In order to achieve the above object, the present invention is achieved by the following technical solution.

A method for producing a high-stability alloy powder, specifically comprising the following steps of:
1. carrying droplets of molten metal with a carrier gas at a temperature above a melting point of the molten metal, feeding the droplets of molten metal into a heat radiation area, and cooling the droplets of molten metal to solidification to obtain particles, wherein a metal content in the droplets of molten metal exceeds 99.9 wt %;
2. mixing the solidified and formed high-temperature solid particles with a fluid at room temperature and rapidly quenching the same, wherein an average temperature of the particles and the carrier gas before the quenching is higher than 500° C., and an average temperature of the particles and the carrier gas after the quenching is lower than 300° C., so as to obtain a structure of compact and stable alloy powder particles;
3. contacting a surface of the droplets of molten metal or the alloy powder particles with an oxygen group element during formation of the droplets of molten metal or after the solidification or the quenching, forming a chemical passivation layer on the surface of the alloy powder particles by reaction with the oxygen group element to form a nickel compound containing the oxygen group element, and controlling an amount of the oxygen group element so that a mass of the oxygen group element is 0.10-15.00 wt % of a mass of the alloy powder;
4. dispersing the alloy powder having the chemical passivation layer containing the oxygen group element in a fluid in a container having a shell with a hard inner wall at room temperature, rotating the fluid carrying the alloy powder in the container by pressure, the rotating alloy powder particles colliding with each other or the rotating alloy powder particles colliding with the hard inner wall of the shell of the container, so that the chemical passivation layer on the surface of the alloy powder particles is denser.

Further, a metal raw material in the droplets of molten metal is at least one of nickel or copper.

Further, the carrier gas is at least one of nitrogen or argon.

Further, the fluid in the step 2 is at least one of an inert gas or a liquid.

Further, the oxygen group element is at least one of oxygen or sulfur.

Further, the alloy powder has an average particle size of 20-1000 nm, an individual particle of the alloy powder is in a substantially spherical shape, a content of metal in the alloy powder particles is 84.00-99.80 wt %, a content of the non-metal and non-oxygen group element is 0.01-1.00 wt %, a content of the oxygen group element is 0.10-15.00 wt %, and the content of the oxygen group element of more than 90 wt % is concentrated in an outer surface layer of the alloy powder particles with a thickness of 5 nm.

The present invention also provides a conductive paste using the above-mentioned high-stability alloy powder.

The present invention also provides a multilayer ceramic capacitor using the electrode made of the above conductive paste.

Compared with the prior art, the invention has the following beneficial effects.

The particles of the high-stability alloy powder prepared by this method undergo the heat radiation cooling and solidification process, and the heat radiation cooling mode has a stable temperature field, which is beneficial to obtain the particles with a substantially spherical shape; the solidified particles are quenched by a cooling fluid at a high temperature, and the surface of the particles rapidly shrinks to form a denser surface layer; the chemical passivation reaction takes place at the surface layer of the particles, and the surface layer where the chemical passivation reaction takes place is compacted by physical impact, and an oxide layer or a sulfide layer in the surface layer changes from a fluffy state to a dense protective layer. High-stability alloy powder particles formed by thermal radiation solidification, fluid quenching, chemical passivation, and physical impact passivation have more stable chemical properties and good dispersibility, and the yield of multilayer ceramic capacitors made of conductive paste made of alloy powder particles is high.

### DESCRIPTION OF THE EMBODIMENTS

The present invention is further described in connection with embodiments which, although clearly and completely described, are intended to represent only some, but not all embodiments of the invention. Based on the embodiments of the present invention, all other embodiments obtained by a person of ordinary skill in the art without involving any inventive effort are within the scope of the present invention.

### Example 1

The droplets of molten microparticles (with a nickel content exceeding 99.9 wt %) are carried by a carrier gas (nitrogen) at a temperature higher than the melting point of nickel by 1453° C., and are sent to a heat radiation area to be cooled to solidification, so as to obtain particles;
the solidified and formed high-temperature solid particles are mixed with a fluid at room temperature and rapidly quenching the same, wherein the average temperature of the particles and the carrier gas before quenching is higher than 800° C., and the average temperature of the particles and the carrier gas after quenching is lower than 200° C., so as to obtain a compact and stable alloy powder particle structure, the average particle size of the particles is 275 nm;
the surface of the particles of droplets of molten metal is contacted with oxygen after quenching to form an oxygen-containing nickel compound on the surface of the more reactive ultrafine particles, the oxygen content of the particles is 0.70 wt %;
in the ceramic cyclone inner chamber, a high-pressure (0.6 MPa) gas is introduced to form a cyclone, the nickel alloy powder with the chemical passivation layer is dispersed in the gas flow and rotates at a high speed, and the rotating nickel alloy powder particles collide with each other or the rotating nickel alloy powder particles collide with the ceramic inner wall of the container shell to compact and to densify the chemical passivation layer on the surface of the particles.

### Example 2

The droplets of molten microparticles (with a nickel content exceeding 99.9 wt %) are carried by a carrier gas (nitrogen) at a temperature higher than the melting point of nickel by 1453° C., and are sent to a heat radiation area to be cooled to solidification, so as to obtain particles;
the solidified and formed high-temperature solid particles are mixed with a fluid at room temperature and rapidly quenching the same, wherein the average temperature of the particles and the carrier gas before quenching is higher than 750° C., and the average temperature of the particles and the carrier gas after quenching is lower than 250° C., so as to obtain a compact and stable alloy powder particle structure, the average particle size of the particles is 72 nm;
the surface of the particles of droplets of molten metal is contacted with oxygen after quenching to form an oxygen-containing nickel compound on the surface of the more reactive ultrafine particles, the oxygen content of the particles is 4.50 wt %;
in the stainless steel cyclone inner chamber, a negative pressure (−0.03 MPa) cyclone was created by drawing an atmospheric air stream from a negative pressure fan, the nickel alloy powder with the chemical passivation layer is dispersed in the gas flow and rotates at a high speed, the rotating nickel alloy powder particles collide with each other or the rotating nickel alloy powder particles collide with the inner wall of the container shell to compact and to densify the chemical passivation layer on the surface of the particles.

### Example 3

The droplets of molten microparticles (with a nickel content exceeding 99.9 wt %) are carried by a current-carrying gas (nitrogen) at a temperature higher than the melting point of nickel by 1453° C., and are sent to a heat radiation area to be cooled to solidification, so as to obtain particles;
the solidified and formed high-temperature solid particles are mixed with a fluid at room temperature and rapidly quenching the same, wherein the average temperature of the particles and the carrier gas before quenching is higher than 750° C., and the average temperature of the particles and the carrier gas after quenching is lower than 200° C., so as to obtain a compact and stable alloy powder particle structure, the average particle size of the particles is 150 nm;
adding sulphur before the molten droplets are not solidified, and the surface of the particles of droplets of molten metal is contacted with oxygen after quenching to form an oxygen-contain containing nickel compound on the surface of the more reactive ultrafine particles, the oxygen content of the particles is 1.30 wt %, the sulphur content of the particles is 0.11 wt %;
in the inner chamber of the ceramic swirling flow tube, a high-pressure (0.8 MPa) liquid is introduced to form a liquid swirling flow, the nickel alloy powder with the chemical passivation layer is dispersed in the liquid flow and rotates at a high speed, the rotating nickel alloy powder particles collide with each other or the rotating nickel alloy powder particles collide with the ceramic inner wall of the container shell to compact and to densify the chemical passivation layer on the surface of the particles.

1. A method for producing an alloy powder, comprising following steps of:
step 1 carrying droplets of molten metal with a carrier gas at a temperature above a melting point of the molten metal, feeding the droplets of molten metal into a heat radiation area, and cooling the droplets of molten metal to solidification to obtain particles, wherein a metal content in the droplets of molten metal exceeds 99.9 wt %;
step 2 mixing the solidified and formed high-temperature solid particles with a fluid at room temperature and rapidly quenching the same, wherein an average temperature of the particles and the carrier gas before the quenching is higher than 500° C., and an average temperature of the particles and the carrier gas after the quenching is lower than 300° C., so as to obtain a structure of compact and stable alloy powder particles;
step 3 contacting a surface of the droplets of molten metal or particle with an oxygen group element during formation of the droplets of molten metal or after the solidification or the quenching, forming a chemical passivation layer on the surface of the particle by reaction with the oxygen group element to form a nickel compound containing the oxygen group element, and controlling an amount of the oxygen group element so that a mass of the oxygen group element is 0.10-15.00 wt % of a mass of the alloy powder; and
step 4 dispersing the alloy powder having the chemical passivation layer containing the oxygen group element in a fluid in a container having a shell with a hard inner wall at room temperature, rotating the fluid carrying the alloy powder in the container by pressure, the rotating alloy powder particles colliding with each other or the rotating alloy powder particles colliding with the hard inner wall of the shell of the container, so that the chemical passivation layer on the surface of the alloy powder particles is denser.

2. The method for producing the alloy powder of claim 1, wherein a metal raw material in the droplets of molten metal is at least one of nickel or copper.

3. The method for producing the alloy powder of claim 1, wherein the carrier gas is at least one of nitrogen or argon.

4. The method for producing the alloy powder of claim 1, wherein the fluid in the step 2 is at least one of an inert gas or a liquid.

5. The method for producing the alloy powder of claim 1, wherein the oxygen group element is at least one of oxygen or sulfur.

6. The method for producing the alloy powder of claim 1, wherein the alloy powder has an average particle size of 20-1000 nm, an individual particle of the alloy powder is in a substantially spherical shape, a content of metal in the alloy powder particles is 84.00-99.80 wt %, a content of non-metal and non-oxygen group element is 0.01-1.00 wt %, a content of the oxygen group element is 0.10-15.00 wt %, and the content of the oxygen group element of more than 90 wt % is concentrated in an outer surface layer of the alloy powder particles with a thickness of 5 nm.

7. The alloy powder, prepared by the method for producing the alloy powder of claim 1.

8. A conductive paste, comprising the alloy powder of claim 7.

9. A multilayer ceramic capacitor, comprising an electrode prepared by the conductive paste of claim 8.
